(19) United States
(12) Patent Application Publication
(10) Pub. No.: US 2013/0048762 A1
(43) Pub. Date: Feb. 28, 2013

(54) SUB-SURFACE IRRIGATOR AND PRECISION WATERING METHOD

(71) Applicant: Nedeljko Ulemek, Mississauga (CA)

(72) Inventor: Nedeljko Ulemek, Mississauga (CA)

(21) Appl. No.: 13/217,056

(22) Filed: Aug. 24, 2011

(51) Int. Cl. B05B 1/00

(52) U.S. Cl. 239/589

(57) ABSTRACT

A sub-surface irrigator and method for watering of plants is provided. The irrigator has an injector tube comprising a wedge-tipped nozzle portion and a water inlet portion coupled to an intermediate location by rotatable mechanism, including a first stage in which an injector tube of a sub-surface spray device is inserted into soil to water the roots of plants and to create tubular watering holes. In a second stage, a toothed collar spray device having a toothed collar container is used to cover and refill the tubular watering holes. The second stage can be repeated independently of the first. A variation of the method uses plant watering apparatus including a handle and an extension pipe for watering from a standing position. A kit comprising of the injector tube and the toothed collar container devices or attachments is also provided.

### BACKGROUND OF THE INVENTION

1. Field of the Invention

This invention relates to a hand operable sub-surface irrigator, more particularly a hand-held apparatus for aerating soil and injecting water below the surface of the soil to the roots of a plant. A method of watering plants by aerating the soil and directing water to the root zone is also provided.

2. Description of the Related Art

Growth of home landscape and garden plants necessitates establishing good water-air relationships. Gardeners appreciate that effectiveness of transferring water from the surface of the soil to the plant's root zone may be impacted, inter alia, by soil hardness and ability to retain oxygen (necessary to avoid suffocation of plant roots), quantity of water deposited on soil surface, and distance between soil surface and plant roots. These and other factors affect the ease with which water permeates downwardly in the direction of the plant root zone.

Moisture is most effectively retained closer to the roots of the plant than at the top of the soil. When pools of water form close to the surface of the soil, as is frequently the case using conventional methods of plant irrigation, water may evaporate or be absorbed by weeds surrounding the plants, thereby diminishing the effectiveness of transfer to plant root zones.

An advantage of the invention is that it opens the soil surface to allow for entry of oxygen. Another advantage is to focus the direction of water to the plant root zone, thereby conserving the amount of water required by the plant. A further advantage of focusing direction of the water transfer to the root zone is to avoid feeding weeds located near the soil surface. The invention also provides the advantage of easy maneuvering in small areas due to the focused shape of the wedge-tip and due to the angle of spray. It also provides the advantage of allowing both left-handed and right-handed directional flow of water by way of a rotation mechanism.

By directing the flow of water into the ground and positioning the apparatus close to the roots of the plant rather than on top of the soil, water run-off is reduced and water is preserved. It is also possible that a gardener create a reservoir of water beneath the roots of a plant, encouraging the water-seeking roots to grow downwards. It is an object of the invention to provide for a method of watering plants that can encourage plant roots to grow downwards by opening the soil surface, and directing the water to a downward location within the soil by positioning the apparatus of the invention close to the plant root zone when delivering watering to the desired sub-surface site location. It is also an object of the invention to provide for a method and apparatus that can aid in repeat watering of plants.

### SUMMARY OF THE INVENTION

The invention provides a sub-surface spray device for watering plant roots, the device having a handle having means for connecting an inlet end of the handle to a water source. The handle has an inlet portion and an outlet portion. The handle defines a fluid passage which joins a water source connected to the handle inlet end to an attachment connected to the handle outlet end. A hand-operable valve mechanism can be used for controlling the rate of water flow through the handle fluid passage. Connected to the handle outlet end is an injector portion which forms a tube for penetrating soil. There may also be an intermediate portion joining the handle outlet end to the injector tube, so that the injector tube may rotate freely. The connection between the injector tube and intermediate portion may be sealed using O-rings. There may also be a gripping portion around the injector tube to facilitate rotation. The injector tube defines a tube passageway within for flow of water from the handle outlet end to a wedge-tipped end surface distal from the handle outlet end. The wedge-tipped end has a sloped end surface with at least one opening for discharge of water possibly perpendicular to the end surface. The rotation of the injector tube allows the direction of the flow to change. The inlet end of the handle is connectable to a water source. In use, the tube is inserted into the soil. A valve mechanism is actuated to discharge a flow of water from the water source, through the injector portion which has at least one opening into the soil beneath a plant at a site close to the plant roots. The sub-surface spray device is removed from the soil for the soil to define a tubular watering hole having a tubular watering hole opening.

The invention further provides for the injector tube being tapered toward the wedge-tipped end, for the sloped end surface of the wedge-tipped end being designed for penetration of the earth's surface, and for the sloped end surface having one or a plurality of openings for possibly parallel discharge of water. This aspect of the invention also provides that the injector tube has a central longitudinal axis and that the sloped end surface defines an angle ranging from 30° to 60° relative to the central longitudinal axis and specifically that the sloped end surface can define an angle of 45° relative to the central longitudinal axis. The injector tube may be able to rotate about the central longitudinal axis.

In one embodiment of the apparatus, a toothed collar spray device is provided for watering plant roots. The toothed collar spray device has a handle having means for connecting an inlet end of the handle to the water source. The handle defines a fluid passage which joins a water source connected to the handle inlet end to another portion connected to the handle outlet end. In use, a hand-operable valve mechanism may control the rate of water flow through the handle fluid passage. A container is connected to the handle outlet end and the container extends between the connection to the handle outlet end and a spray head portion distal from the handle outlet end, defining a passageway for the water. There may be an intermediate portion that connects the outlet end of the handle and the container. The container or the spray head may include a switch for stopping the flow of water. The container or the spray head may also include a mechanism that allows the rate or type of spray to be adjusted. The spray head has at least one opening for discharge of water. The spray head is connected to a collar that extends distal to the handle outlet end and has collar teeth for engaging the soil. The collar has a diameter larger than the diameter of the tubular watering hole opening created by the injector tube of the sub-surface spray device. The toothed collar spray device can be connected to the water source after the sub-surface spray device is disconnected from the water source. The toothed collar spray device is positioned such that the collar surrounds the tubular watering hole opening and the collar teeth engage the soil top surface, and the hand-operable valve mechanism is actuated to discharge a flow of water into the tubular watering hole. The toothed collar spray device may also be positioned so that it is placed against the ground near the plant (instead of over the tubular watering hole opening). When the collar teeth engage the soil on the surface, the collar confines the water so that the collar portion fills with water when pressed against the ground, allowing for maximum absorbance into the soil. The invention further provides for the container or the collar being cylindrical-shaped, cone-shaped or bell-shaped.

Another aspect of the invention provides for using the injector tube attachment or toothed collar container attachment described above without the described handle portion of the spray device. The attachments may be connected directly to a water source or other instrument. Another aspect of the invention provides the injector tube attachment or toothed collar container attachment may also be connected to a handle with an extension pipe. The extension pipe would connect to a handle having means for connecting an inlet end of the handle to a water source. The handle defines a fluid passage within the handle which joins a water source connected to the handle inlet end to another portion connected to the handle outlet end. A hand-operable valve mechanism may be used for controlling the rate of water flow through the handle fluid passage. The handle outlet end connects to the extension pipe inlet end, and the extension pipe outlet end may attach to either the injector tube attachment or toothed collar container attachment described above, defining a passageway for the water. The outlet end of the injector attachment tube may also be connected to another extension pipe. There may be a length adjusting means for the extension pipe. For example, there may be two or more extension pipes that connect to each other, and one extension pipe may fit inside another so they can slide and contract like a telescope. Any of the extension pipes may be either straight or curved for inserting the injector tube into the soil at a different angle and for positioning the toothed collar container from a different approach angle.

Another aspect of the invention provides for a method of controlled water delivery to plant roots which includes providing a sub-surface spray apparatus for watering plant roots with the apparatus having a handle inlet, a handle inlet end, a handle outlet and a handle outlet end and means for connecting the handle inlet end to a water source. A handle fluid passage within the handle connects the handle inlet end to the handle outlet end. A hand-operable valve mechanism is used for controlling the rate of water flow through the handle fluid passage. The extension pipe has a pipe inlet, a pipe inlet end, a pipe outlet, a pipe outlet end. The pipe defines a pipe fluid passage connecting the pipe inlet end and the pipe outlet end. The pipe inlet end is attached to the handle outlet end. An injector tube for penetrating the soil is connected to the pipe outlet end. The injector tube has a tube passageway within for flow of water from the pipe outlet to a wedge-tipped end distal from the pipe outlet end. The wedge-tipped end has a sloped end surface with at least one opening for discharge of water. The inlet end of the handle is connected to the water source. The injector tube is inserted into the soil. The hand-operable valve mechanism is actuated to discharge a flow of water from at least one opening into the soil beneath a plant. The injector tube is removed from the soil such that the soil defines a tubular watering hole having a tubular watering hole opening. A toothed collar container attachment is provided having a connection end attachable to the pipe outlet end. A container extends from the connection end to a spray head portion distal from the pipe outlet end. The spray head is connected to a collar with collar teeth for engaging the soil. The collar defines a perimeter for encompassing the perimeter defined by the tubular watering hole opening. The injector tube is disconnected from the pipe outlet end and the spray head is connected to the pipe outlet end. The toothed collar container apparatus is positioned such that the collar teeth surround the tubular watering hole opening and engage the soil top surface with the collar teeth and the hand-operable valve mechanism is actuated to discharge a flow of water into the tubular watering hole. This aspect of the invention further provides that the extension pipe may have a length adjusting means or there may be two or more extension pipes that connect to each other. It also further provides that the extension pipe may be straight or it may be curved for inserting the injector tube into the soil at a different angle and for positioning the toothed collar container from a different approach angle.

It is another aspect of the invention to provide for a sub-surface irrigator for watering plant roots, the sub-surface irrigator comprising a handle having a handle inlet, a handle inlet end, a handle outlet and a handle outlet end and means for connecting the handle inlet end to a water source. A handle fluid passage within the handle connects the handle inlet to the handle outlet and a hand-operable valve mechanism is used for controlling the rate of water flow through the handle fluid passage. An extension pipe has a pipe inlet, a pipe inlet end, a pipe outlet, a pipe outlet end and a pipe wall defining a pipe fluid passage connecting the pipe inlet and the pipe outlet. The pipe inlet end is attached to the handle outlet end. An injector tube for penetrating soil is attached to the pipe outlet end, with the injector tube having a tube passageway within for flow of water from the pipe outlet to a wedge-tipped end that is distal from the pipe outlet end. The wedge-tipped end has a sloped end surface with at least one opening for discharge of water whereby the injector tube can be inserted into the soil and the hand-operable mechanism can be actuated to discharge a flow of water from at least one opening toward the roots of the plant. The invention also provides for the injector tube being tapered toward the wedge-tipped end, the sloped end surface of the wedge-tipped end being flat and the sloped end surface having a plurality of openings. It is further provided that the injector tube has a central longitudinal axis and that the injector tube may be connected to the pipe outlet end in a manner that allows for rotation of the injector tube about the central longitudinal axis. The sub-surface irrigator aspect of the invention further provides that the extension pipe may have a length adjusting means or there may be two or more extension pipes that connect to each other. It also further provides that the extension pipe may be straight or it may be curved or bent.

It is another aspect of the invention to provide for a toothed collar irrigator for watering plant roots, the toothed collar irrigator comprising a handle having a handle inlet, a handle inlet end, a handle outlet and a handle outlet end and means for connecting the handle inlet end to a water source. A handle fluid passage within the handle connects the handle inlet to the handle outlet and a hand-operable valve mechanism is used to control the rate of water flow through the handle fluid passage. An extension pipe has a pipe inlet, a pipe inlet end, a pipe outlet, a pipe outlet end and a pipe wall defining a pipe fluid passage connecting the pipe inlet and the pipe outlet. The pipe inlet end is attached to the handle outlet end. A container is connected to the pipe outlet end and extends between the connection and a spray head portion. The spray head is connected to a collar, with the collar distal from said extension pipe and ending in collar teeth for engaging soil. This aspect of the invention further provides that the extension pipe may have a length adjusting means or there may be two or more extension pipes that connect to each other. It also further provides that the extension pipe may be straight or it may be curved.

The invention further provides a kit for watering plant roots comprising, firstly, the sub-surface spray device as previously described wherein the water source is a garden hose, and the means for connecting an inlet end of the handle to a water source is connectable to the garden hose and, secondly, the toothed collar spray device as previously described wherein the water source is a garden hose and the means for connecting an inlet end of the handle to a water source is connectable to the garden hose.

The invention also provides for a kit for watering plant roots incorporating the injector tube attachment as previously described and the toothed collar container attachment also as previously described.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIG. 1 is a side elevation view of a sub-surface spray device and a cross section view of the injector tube attachment;

FIG. 2 is a side elevation view of a toothed collar spray device;

FIG. 3 is a side elevation view of spray apparatus having an extension pipe; and

FIG. 4 shows a side elevation view of a detached injector tube attachment and a detached toothed collar container attachment.

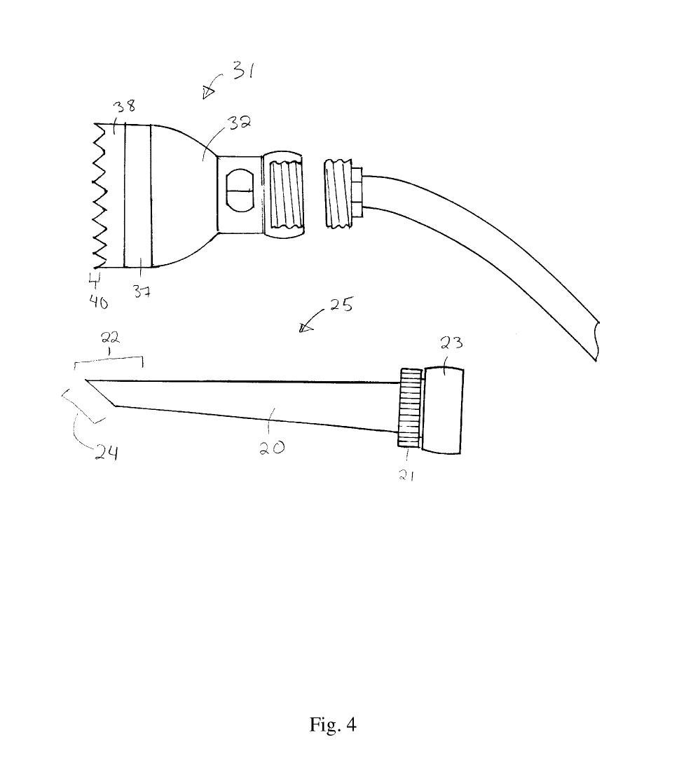

### PARTS LIST

10 sub-surface spray device
12 handle
14 handle inlet end
16 handle outlet end
18 valve mechanism
20 injector tube
21 gripping portion
22 wedge-tipped end
23 intermediate portion
24 sloped end surface
25 injector tube attachment
26 opening
28 flow of water
30 toothed collar spray device
31 toothed collar container attachment
32 container
38 collar
40 collar teeth
42 extension pipe
42A additional extension pipe
44 extension pipe inlet end
44A additional extension pipe inlet end
46 extension pipe outlet end
46A additional extension pipe outlet end

### DESCRIPTION OF THE PREFERRED EMBODIMENTS

The complete method of the invention is a two-stage method, but each of the stages can be performed individually when it is advantageous. The apparatus employed toward the method of the invention can vary in terms of size and attachments. The apparatus can be described for each stage individually or for both stages together as a kit.

In the description and the drawings like parts are designated by like numbers.

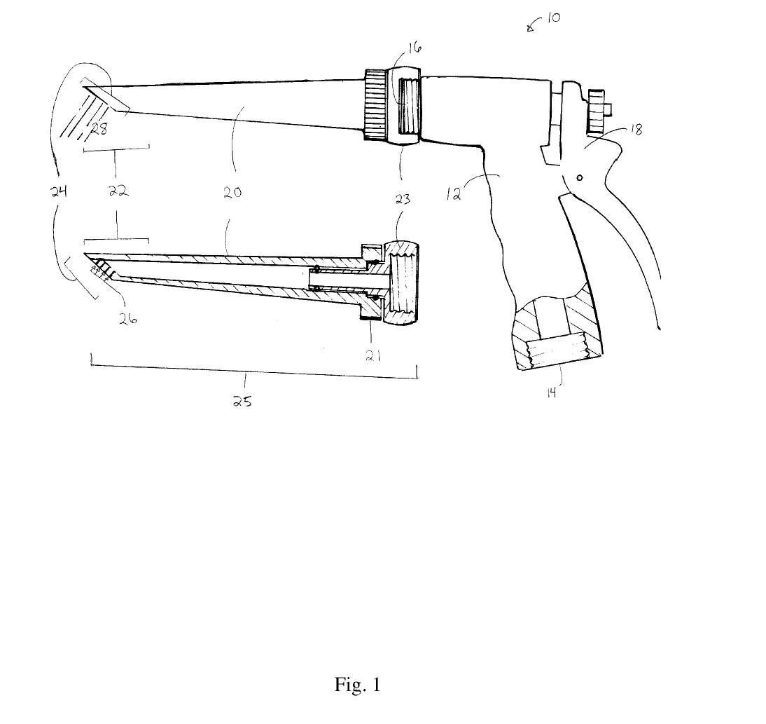

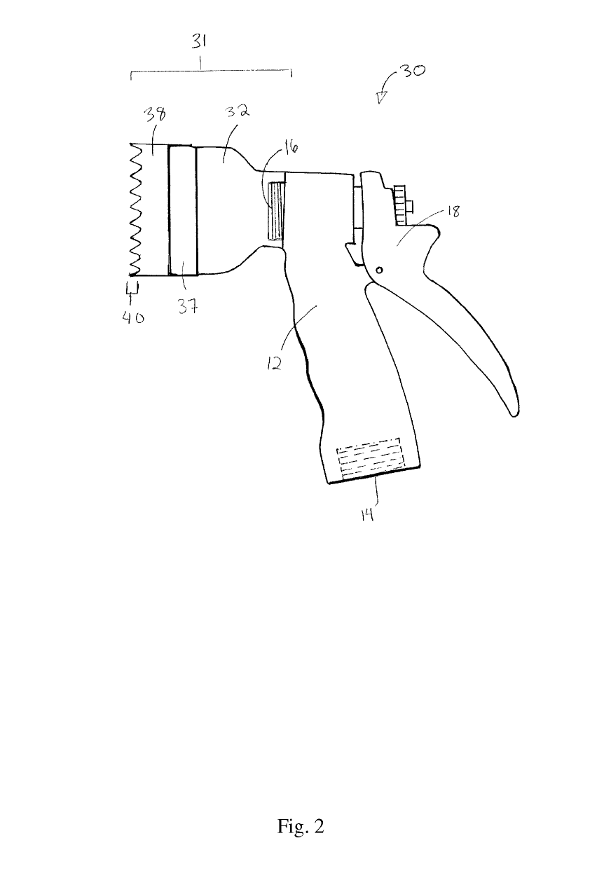

An embodiment of the invention is for a method of watering plants. The method includes providing sub-surface spray device 10 (FIG. 1) for watering plant roots, the spray device having handle 12 having means for connecting inlet end 14 of handle 12 to a water source. The handle defines a handle fluid passage connecting a handle inlet end 14 to handle outlet end 16. Hand-operable valve mechanism 18, of which a handle part is visible in FIG. 1, can be used for controlling the rate of water flow through the handle fluid passage. Injector tube 20 has a first and second portion connected by an intermediate portion 23. The first portion is for penetrating soil, and the second portion is connected to intermediate portion 23 and may have a gripping portion 21. The handle injector tube 20 thus defines a tube passageway within (as shown in the cross section) for the flow of water from the handle outlet to wedge-tipped end 22 distal from handle outlet end 16. Wedge-tipped end 22 has sloped end surface 24 with at least one opening 26 for discharge of water possibly perpendicular to end surface 24. Inlet end 14 of handle 12 is connected to the water source, likely a garden hose. Injector tube 20 is inserted into the soil. Hand-operable valve mechanism 18 is actuated to discharge flow of water 28 from at least one opening 26 into the soil beneath a plant. A plurality of openings 26 is preferred to having a single opening 26. It is preferred that the injector tube 20 is rotated and opening(s) 26 positioned so that flow of water 28 will be directed under the roots of a plant. The spray device is removed from the soil for the soil to define a tubular watering hole having a tubular watering hole opening. One or more holes can be created for a plant, depending on requirements. Toothed collar spray device 30 (FIG. 2) is provided for watering plant roots. Toothed collar spray device 30 has handle 12 having means for connecting handle inlet end 14 of handle 12 to the water source. The handle defines a handle fluid passage connecting handle inlet end 14 to handle outlet end 16. Hand-operable valve mechanism 18 is used for controlling the rate of water flow through the handle fluid passage. Handle 12 and hand-operable valve mechanism 18 of toothed collar spray device 30 may be identical to those of sub-surface spray device 10 or may have variations. A container 32 is connected to handle outlet end 16. Container 32 extends between the connection to handle outlet end 16 and spray head 37. Different configurations of the spray head are possible, including there being a single opening or a plurality of openings. Spray head 38 is connected to a collar 38 which has collar teeth 40 distal from handle 12 for engaging the soil. Collar 38 has a diameter larger than the diameter of the tubular watering hole opening. Sub-surface spray device 10 can be disconnected from the water source and handle inlet end 14 of toothed collar spray device 30 can be connected to the water source. Toothed collar spray device 30 is positioned such that collar teeth 40 surround the tubular watering hole opening and engage the soil top surface and then hand-operable valve mechanism 18 is actuated to discharge a flow of water into the tubular watering hole. The collared container helps to direct water flow into the tubular watering hole and helps to control spray and flying debris.

The tubular watering hole may remain in tact for use at a future time, and the gardener can skip using sub-surface spray device 10 and start watering using toothed collar spray device 30, thus saving time. There are further variations of the method of use of toothed collar spray device 30. It is possible for collar 38 and collar teeth 40 to engage the ground to create a water-tight seal to prevent runoff when a relatively small amount of water is sprayed. And it is also possible to use toothed collar spray device 30 directly in contact with the ground even when no hole is in the ground.

By directing the flow of water into the ground and positioning the apparatus close to the roots of the plant rather than on top of the soil, water run-off is reduced and water is preserved. It is also possible that a gardener create a reservoir of water beneath the roots of a plant, encouraging the water-seeking roots to grow downwards.

The present invention also embodies variations to the apparatus. The invention can include injector tube 20 being tapered toward wedge-tipped end 22 or being non-tapered, sloped end surface 24 of wedge-tipped end 22 being flat or rounded, and sloped end surface 24 having a plurality of openings 26 for possibly parallel discharge of water. The invention also includes the option that sloped end surface 24 can define an angle ranging from 30° to 60° relative to the central longitudinal axis of the injector tube and more specifically sloped end surface 24 can define an angle of 45° relative to the central longitudinal axis. It is also possible that wedge-tipped end 22 could have two sloped surfaces to form a v-shaped end or could have a pointed conical end. Injector tube 20 can be connected to handle outlet end 16 by commonly known means for rotation of injector tube 20 about the central longitudinal axis to direct the flow of water from wedge-tipped end 22 in different directions. The invention further includes the toothed collar 38 or container 32 being cylindrical-shaped, cone-shaped or bell-shaped. Collar 38 could be a separate part that is possibly detachable, as seen in FIG. 2, or it could be formed integral with container 32.

This invention also embodies providing injector tube attachment 25 (which may or may not include intermediate portion 23 and gripping portion 21) by itself as an attachment for a common spray device and providing toothed collar container attachment 31 individually as an attachment for a common spray device. Common spray devices can have a configuration similar to those of FIGS. 1 and 2, without the attachments, or could have different general configurations while still achieving the same functional results.

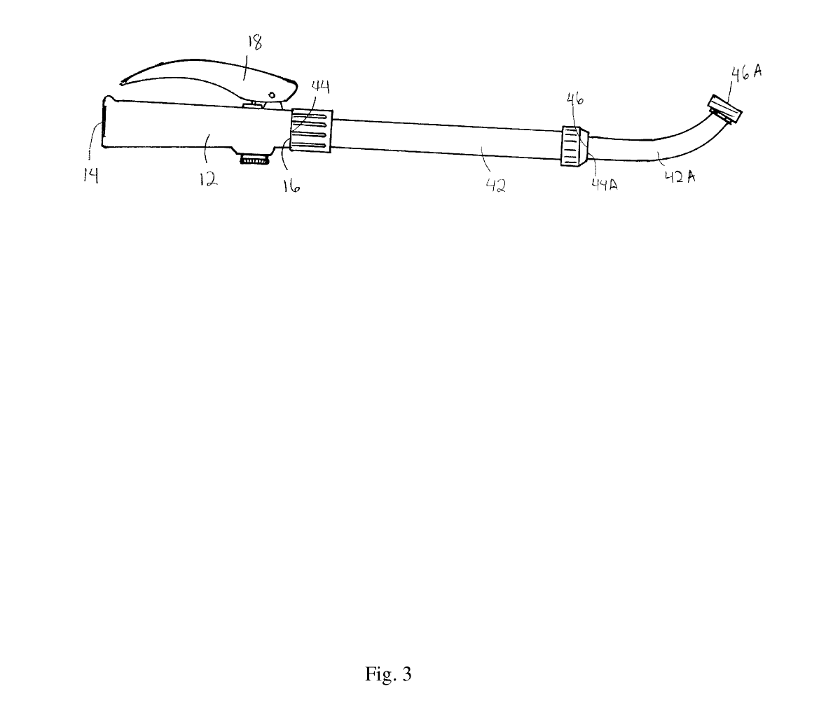

Another embodiment of the invention is for a method of controlled water delivery to plant roots which uses the extension pipe spray apparatus of FIG. 3. The apparatus includes handle 12 having a handle inlet, handle inlet end 14, a handle outlet, and handle outlet end 16 and means for connecting handle inlet end 14 to a water source. The connecting means could be a threaded connector for use with a common garden hose or possibly slide-on connectors. Handle fluid passage within handle 12 connects the handle inlet to the handle outlet. Hand-operable valve mechanism 18, of which the handle part is shown in FIG. 3, is used for controlling the rate of water flow through the handle fluid passage. Extension pipe 42 has a pipe inlet, pipe inlet end 44, a pipe outlet, pipe outlet end 46 and the pipe wall defines a pipe fluid passage (not shown) connecting the pipe inlet and the pipe outlet. Pipe inlet end 44 is attached to handle outlet end 16. Injector tube attachment 25 for penetrating the soil, as shown in FIG. 1, is connected to pipe outlet end 46. Injector tube attachment 25 can vary in shape and size. Injector tube 20 of the injector tube attachment 25 has a central longitudinal axis, and can be connected to extension pipe outlet end 46 for rotation of injector tube 20 about the central longitudinal axis to direct the flow of water from the wedge-tipped end in different directions. Inlet end 14 of the handle is connected to the water source. Injector tube 20 is inserted into the soil. Hand-operable valve mechanism 18 is actuated to discharge a flow of water from at least one opening 26 into the soil beneath a plant. Injector tube 20 is removed from the soil such that the soil defines a tubular watering hole having a tubular watering hole opening. Toothed collar container attachment 31, as shown in FIG. 2, is can be connected to pipe outlet end 46 such that the container 32 extends from the connection end to a spray head portion distal from the pipe outlet end 46. The spray head portion is connected to collar 38 which has collar teeth 40 for engaging the soil. Collar 38 defines a perimeter for encompassing the perimeter defined by the tubular watering hole opening. Injector tube attachment 25 is disconnected from pipe outlet end 46 and toothed collar container attachment 31 is connected to pipe outlet end 46. Toothed collar container attachment 31 is positioned such that collar teeth 40 surround the tubular watering hole opening and engage the soil top surface, and hand-operable valve mechanism 18 is actuated to discharge a flow of water into the tubular watering hole. Extension pipe 42 can be a single piece of a fixed length. It is also possible that extension pipe 42 have length adjusting means, such as an additional extension pipes telescopically extending from a relatively larger diameter pipe as seen in FIG. 3. There may be one or more additional extension pipes 42A with pipe inlet ends 44A and pipe outlet ends 46A that can connect to attachments 25 and 31. As shown in FIG. 3, the invention can include any of the extension pipes being curved or bent for inserting injector tube attachment 25 into soil at a different angle and for positioning toothed collar container attachment 31 from a different approach angle. Extension pipe 42 allows the gardener to do sub-surface watering from a standing position and to easily walk from plant to plant, eliminating the need to squat or kneel while watering and crawl or stand back up to move between plants, thereby increasing comfort and efficiency.

The invention further embodies providing a sub-surface irrigator having injector tube 20 attached to extension pipe 42 as a unit. Also, the invention embodies a toothed collar irrigator when toothed collar container attachment 31 is attached to extension pipe 42 as a unit. The sub-surface irrigator unit and the toothed collar irrigator unit both have the options of extension pipe 20 being adjustable or fixed in length and having a bend.

It is also an embodiment of the invention to provide a kit for watering plant roots that includes sub-surface spray device 10 as previously described and toothed collar spray device 30 as previously described. The inlet ends of the spray device bodies could have threaded connectors for use with a common garden hose or the inlet ends could have alternative connection means, such as slide-on connectors.

It is a further embodiment to provide a kit for watering plant roots including injector tube attachment 25 as previously described and toothed collar container attachment 31 as previously described. The injector tube and the toothed collar container attachments of the kit could be attachable to handle 12 as previously described or be attachable to extension pipe 42 as previously described.

It will be understood, of course, that modifications can be made in the embodiments of the invention described herein without departing from the scope and purview of the invention as defined by the appended claims.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A sub-surface spray device for watering plant roots, said sub-surface spray device comprising:
a handle having an inlet end, means for connecting said inlet end of said handle to a water source;
a handle outlet end, said handle defining a handle fluid passage connecting said handle inlet end to said handle outlet end;
a hand-operable valve mechanism for controlling a rate of water flow through said handle fluid passage;
an injector tube for penetrating soil connected to an outlet end of a body, said injector tube having a tube passageway within it for flow of water from said handle outlet end to a wedge-tipped end that is distal from said handle outlet end;
said wedge-tipped end having a sloped end surface with at least one opening for discharge of water;
whereby when said injector tube is inserted into soil and said hand-operable valve mechanism is actuated to discharge a flow of water from said wedge-tipped end to water the roots of a plant.

2. The sub-surface spray device of claim 1, wherein said injector tube is tapered toward said wedge-tipped end.

3. The sub-surface spray device of claim 2, wherein said sloped end surface of said wedge-tipped end is flat.

4. The sub-surface spray device of claim 3, wherein said injector tube has a central longitudinal axis and said sloped end surface defines an angle ranging from 30° to 60° relative to said central longitudinal axis.

5. The sub-surface spray device of claim 3, wherein said injector tube has a central longitudinal axis and said sloped end surface defines an angle of 45° relative to said central longitudinal axis.

6. The sub-surface spray device of claim 3, wherein said sloped end surface has a plurality of openings to discharge water.

7. A sub-surface irrigator for watering plant roots, said sub-surface irrigator comprising:
a handle having an inlet end, a handle outlet end and means for connecting said handle inlet end to a water source;
a handle fluid passage within said handle connecting said handle inlet end to said handle outlet end;
a hand-operable valve mechanism for controlling a rate of water flow through said handle fluid passage;
an extension pipe having a pipe inlet at a pipe inlet end, a pipe outlet at a pipe outlet end and a pipe wall defining a pipe fluid passage connecting said pipe inlet and said pipe outlet;
said pipe inlet end attached to said handle outlet end;
an injector tube for penetrating soil attached to said pipe outlet end, said injector tube having a tube passageway within it for flow of water from said pipe outlet to a wedge-tipped end that is distal from said pipe outlet end;
said wedge-tipped end having a sloped end surface with at least one opening for discharge of water;
whereby when said injector tube is inserted into soil and said hand-operable valve mechanism is actuated to discharge a flow of water from said wedge-tipped end toward the roots of a plant.

8. The sub-surface irrigator for watering plant roots of claim 7, wherein said extension pipe has length adjusting means.

9. The sub-surface irrigator for watering plant roots of claim 7, wherein said extension pipe is curved or has a bend in it.

10. The sub-surface irrigator for watering plant roots of claim 7, wherein said injector tube is tapered toward said wedge-tipped end.

11. The sub-surface irrigator for watering plant roots of claim 10, wherein said sloped end surface of said wedge-tipped end is flat.

12. The sub-surface irrigator for watering plant roots of claim 11, wherein said sloped end surface has a plurality of openings.

13. The sub-surface irrigator for watering plant roots of claim 7, wherein said injector tube has a central longitudinal axis and said injector tube is connected to said pipe outlet end for rotation of said injector tube about said central longitudinal axis.

14. A subsurface tubular irrigator for channeling fluid therethrough to the roots of a plant, comprising:
a fluid inlet portion; and
a fluid outlet injector defining a wedge-tipped end having a sloped surface with at least one opening for discharging fluid, an intermediate portion coupling the fluid inlet and fluid outlet injector for positioning the fluid outlet injector portion, whereby rotation of the intermediate portion positions the least one opening of the injector position for deflection of water in the direction of the roots as water is injected.
